(19) United States
(12) Patent Application Publication
(10) Pub. No.: US 2010/0196656 A1
(43) Pub. Date: Aug. 5, 2010

(54) COMPOSITE BOARD WITH A HONEYCOMB CARDBOARD

(76) Inventor: Luhao Leng, Fujian (CN)

Correspondence Address: RABIN & Berdo, PC, 1101 14TH STREET, NW, SUITE 500, WASHINGTON, DC, 20005, US

(21) Appl. No.: 12/518,673

(22) PCT Filed: Dec. 16, 2003
(86) PCT No.: PCT/CN03/01070

§ 371 Date: Apr. 12, 2010

(30) Foreign Application Priority Data
Jan. 20, 2003 (CN) 30214864.X

(51) Int. Cl. B32B 3/12

(52) U.S. Cl. 428/116

(57) ABSTRACT

A composite board with a honeycomb cardboard has a top board and bottom board pasted to both sides of the honeycomb cardboard. The honeycomb cardboard, top board, and bottom board form an integrated composite board. The honeycomb cardboard consists of bottom paper, top paper and honeycomb paper. The top paper and bottom paper are pasted to both sides of the honeycomb paper. A fortifier can be added between top board and the bottom board. There is a sealing edge which can adopt different structures and qualities.

### TECHNOLOGY FIELD

The invention belongs to daily necessities like furniture, relates to a structure of panel, particularly to structure of composite panel.

### BACKGROUND OF THE INVENTION

Original log desk is top grade and of antiquity, is people's favorite. Due to the scarcities of timber resources and limit to fell, and nature conservation, woodiness material is not advocated. So the fiberboard and the flakeboard is used in the conference table, table, computer desk, backrest board of chair, bookshelf, wardrobe, when the density of fiberboard and the flakeboard is high, the products made of fiberboard or the flakeboard are hard to move; when the density of fiberboard and the flakeboard is low, the intensity of the products made of fiberboard and the flakeboard is weak, and is easy to broken; and the cost of the products made of fiberboard and the flakeboard is high.

The blow moulding panel, which is easy for cleaning and is light, is produced, the interior of the blow moulding panel is hollow, so the many concave units having reinforcing agent is provided on the bottom face to support the top board, and the disadvantage is as following: the table top is unevenness, the intensity is weak; for enhancing the intensity of the table top, the thickness of material can not be thin and lead to the cost is high, the product is too heavy; and due to the thickness of material can not be thin and lead to the production cycle is long, production efficiency is low, and the cost is high.

### SUMMARY OF THE INVENTION

The purpose of this invention is to provide a composite board with a honeycomb cardboard, which is light, high intensity, easy for cleaning, environmental protection, and wide usability.

A composite board with a honeycomb cardboard based on present invention, comprising: a bottom board, a top board and a honeycomb cardboard, the top board and bottom board are pasted to the upside and underside of the honeycomb cardboard respectively, honeycombs are perpendicular to the bottom board and the top board.

Said honeycomb cardboard is made of a single layer honeycomb paper.

Said top board or said bottom board are made of plywood or wooden panel; the thickness is between 0.5 mm to 5 mm.

Said top board or said bottom board are made of melamine panel or fireproof shutter.

Said top board or said bottom board are made of plastic sheet processed by screw extruder, the thickness is between 0.3 mm to 4 mm.

Said top board or said bottom board are made of plastic sheet processed by screw extruder, then processed by vacuum forming or hot briquetting, the thickness is between 0.3 mm to 4 mm.

The shapes of said top board or said bottom board are square; rectangle; circular, the shapes of said top board are adaptive to the shapes of said bottom board.

The shapes of said top board and said bottom board are irregular, the shapes of said top board are adaptive to the shapes of said bottom board.

A reinforcement is provided between said top board and said bottom board.

Said bottom board and said honeycomb cardboard and said top board are fixed, their peripheries are surrounded completely or partly by the sealing edge.

The above-mention structure is adopted, the honeycomb cardboard is located between the top board and the bottom board, and they are pasted together to constitute an integrated composite board, said honeycomb cardboard is composed of a bottom paper, a top paper and a honeycomb paper, the top paper and the bottom paper are respectively pasted to the upside and the underside of the honeycomb paper, so the top face and the bottom face of the honeycomb cardboard are even, and it is easy for paste with the top board and the bottom board, the force applying to the top board and the bottom board applies to the honeycomb paper via the top paper and the bottom paper, and the honeycomb paper will not be broken because of partial force, and can strongly support the top board and the bottom board, enhancing the operation intensity and the steady, the honeycomb cardboard is light; if the reinforcement is provided between said top board and said bottom board, not only enhancing the intensity of the composite board but also enhancing the connection strength between the bindiny mechanisms e.g. table legs and the composite board; The sealing edge is provided, which is useful for reinforcing the connecting, can adopt different structures and qualities of sealing edges to decorate or intersperse the composite board.

The shape of the composite board based on the present invention can be made as square, rectangular, round, polygonal or profiled, the composite board can be used as the table top of council board; computer table; and other kinds of table; so the composite board based on the present invention, which is light, high intensity, good moisture resistance, easy for cleaning, environmental protection, and wide usability.

### BRIEF DESCRIPTION OF THE DRAWINGS

Details of the invention and of the preferred embodiments thereof will be further understood upon reference to the drawings wherein.

FIG. 1 is a partial structure view of the first embodiment based on the present invention;

FIG. 2 is a structure view of the honeycomb cardboard of the first embodiment based on the present invention;

FIG. 3 is a top view of the honeycomb cardboard of the first embodiment based on the present invention;

FIG. 4 is a partial structure view of the second embodiment based on the present invention;

FIG. 5 is a partial structure view of the third embodiment based on the present invention;

FIG. 6 is a partial structure view of the fourth embodiment based on the present invention;

FIG. 7 is a partial structure view of the fifth embodiment based on the present invention.

### DESCRIPTION OF THE PREFERRED EMBODIMENTS

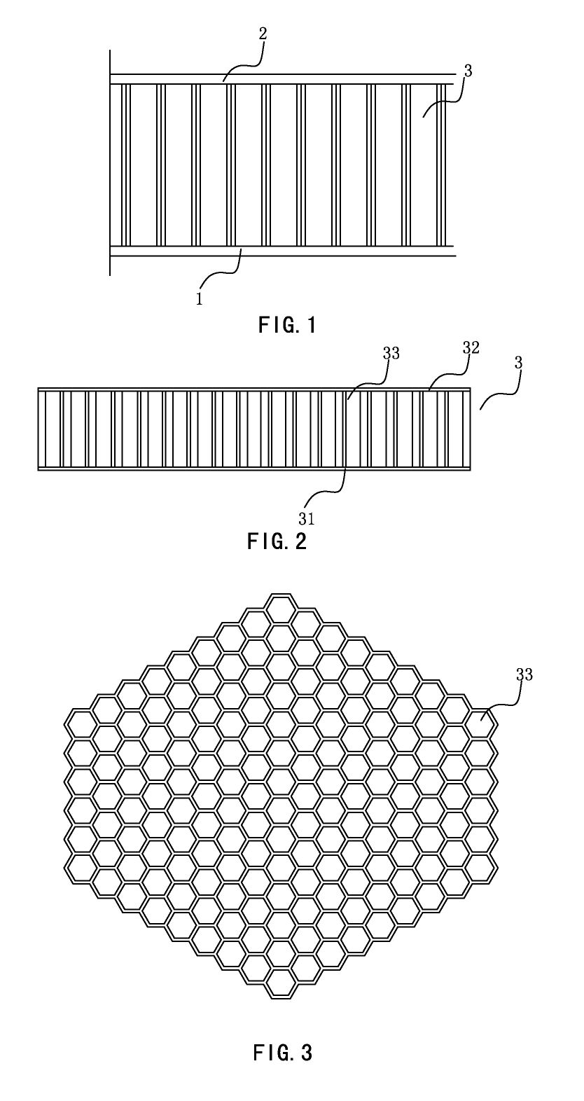

The first embodiment, referring to FIG. 1 and FIG. 2, FIG. 3, a composite board with a honeycomb cardboard based on present invention, comprising: a bottom board 1, a top board 2 and a honeycomb cardboard 3, the top board 2 and the bottom board 1 are pasted to the upside and underside of the honeycomb cardboard 3 respectively, said honeycomb cardboard 3 is composed of a bottom paper 31, atop paper 32 and a single layer honeycomb paper 33, the top paper 32 and the bottom paper 31 are respectively pasted to the upside and the underside of the honeycomb paper 33; the top board 2 and the bottom board 1 are made of plywood, the thickness is between 0.5 mm to 5 mm, the shapes of said top board are adaptive to the shapes of said bottom board.

The above-mention structure is adopted, the honeycomb cardboard 3 is located between the top board 2 and the bottom board 1, and they are pasted together to constitute an integrated composite board, said honeycomb cardboard 3 is composed of a bottom paper 31, a top paper 32 and the honeycomb paper 33, the top paper 32 and the bottom paper 31 are respectively pasted to the upside and the underside of the honeycomb paper 33, so the top face and the bottom face of the honeycomb cardboard 3 are even, and it is easy for paste with the top board 2 and the bottom board 1, the force applying to the top board 2 and the bottom board 1 applies to the honeycomb paper 33 via the top paper 32 and the bottom paper 31, and the honeycomb paper 33 will not be broken because of partial force, and can strongly support the top board 2 and the bottom board 1, enhancing the operation intensity and the steady, the honeycomb cardboard 3 is light; without increasing the weight of the composite board, the intensity of the present invention is greatly enhanced, and the top board and the bottom board are made of the materials, which are easy for cleaning and “green”, so the present invention is wide range of uses, and it is easy to promote the use.

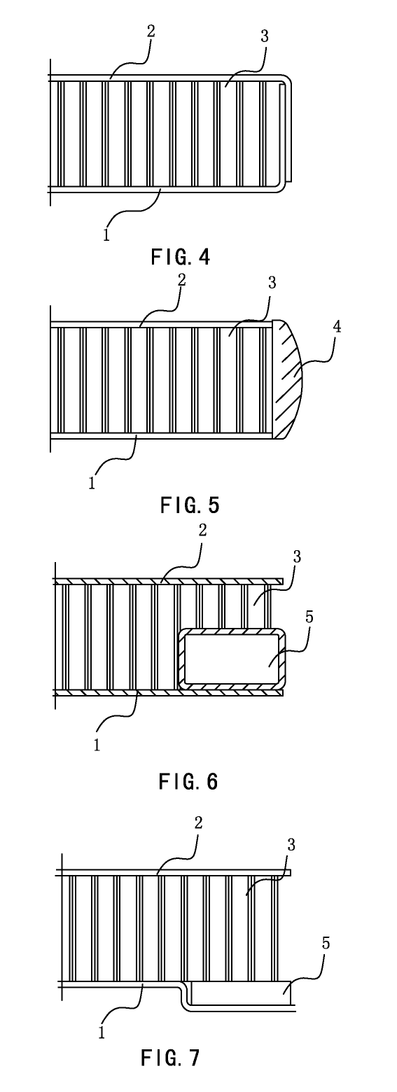

The second embodiment, referring to FIG. 4, the difference differring from the first embodiment is: the top board 2 and the bottom board 1 are made of veneer, the peripheries of the top board 2 and the bottom board 1 fasten and seal off each other.

The third embodiment, referring to FIG. 5, the difference differring from the first embodiment is: the top board 2 is made of melamine panel, the peripheries of the top board 2, the honeycomb cardboard 3, and the bottom board 1, which is made of fireproof shutter, are surrounded by the sealing edge 4.

The sealing edge 4 is provided, which is useful for reinforcing the connecting, can adopt different structures and qualities of sealing edges 4 to decorate or intersperse the composite board.

The fourth embodiment, referring to FIG. 6, the difference differring from the first embodiment is: the top board 2 and the bottom board 1 are made of plastic sheet processed by screw extruder, the thickness are 1.5 mm. The reinforcement 5 is provided in the honeycomb cardboard 3, not only enhancing the intensity of the composite board but also enhancing the connection strength between the bindiny mechanisms e.g. table legs and the composite board.

The fifth embodiment, referring to FIG. 7, the difference differring from the first embodiment is: the top board 2 and the bottom board 1 are made of plastic sheet processed by screw extruder, then processed by vacuum forming or hot briquetting the thickness are 2 mm. The reinforcement 5 is provided between the honeycomb cardboard 3 and the bottom board 1, not only enhancing the intensity of the composite board but also enhancing the connection strength between the bindiny mechanisms e.g. table legs and the composite board, this composite board is different from the traditional wooden panel; fiberboard and the flakeboard, and is different from the blow moulding panel, this composite board is light, high intensity, good moisture resistance, easy for cleaning, environmental protection, and wide usability.

### INDUSTRY PRACTICABILITY

A composite board with a honeycomb cardboard based on present invention, comprising: a bottom board, a top board and a honeycomb cardboard, the top board and bottom board are pasted to the upside and underside of the honeycomb cardboard respectively, honeycombs are perpendicular to the bottom board and the top board, which is light, high intensity, good moisture resistance, easy for cleaning, environmental protection, industrial production of large quantities and widely used in home or office furniture.

What is claimed is:

1. A composite board with a honeycomb cardboard, comprising:
a bottom board, a top board and a honeycomb cardboard, the top board and the bottom board are pasted to the upside and underside of the honeycomb cardboard respectively, honeycombs are perpendicular to the bottom board and the top board.

2. The composite board with a honeycomb cardboard according to claim 1, wherein the honeycomb cardboard is composed of a bottom paper, a top paper and a honeycomb paper, the top paper and the bottom paper are respectively pasted to the upside and the underside of the honeycomb paper.

3. The composite board with a honeycomb cardboard according to claim 2, wherein said honeycomb paper is made of a single layer honeycomb paper.

4. The composite board with a honeycomb cardboard according to claim 1, wherein said top board or said bottom board are made of plywood or veneer; the thickness is between 0.5 mm to 5 mm.

5. The composite board with a honeycomb cardboard according to claim 1, wherein said top board or said bottom board are made of melamine panel or fireproof shutter.

6. The composite board with a honeycomb cardboard according to claim 1, wherein said top board or said bottom board are made of plastic sheet processed by screw extruder, the thickness is between 0.3 mm to 4 mm.

7. The composite board with a honeycomb cardboard according to claim 1, wherein said top board or said bottom board are made of plastic sheet processed by screw extruder, then processed by vacuum forming or hot briquetting, the thickness is between 0.3 mm to 4 mm.

8. The composite board with a honeycomb cardboard according to claim 1, wherein the shapes of said top board and said bottom board are square; rectangle; circular, the shapes of said top board are adaptive to the shapes of said bottom board.

9. The composite board with a honeycomb cardboard according to claim 1, wherein the shapes of said top board and said bottom board are irregular, the shapes of said top board are adaptive to the shapes of said bottom board.

10. The composite board with a honeycomb cardboard according to claim 1, wherein a reinforcement is provided between said top board and said bottom board.

11. The composite board with a honeycomb cardboard according to claim 1, wherein said bottom board and said honeycomb cardboard and said top board are fixed, their peripheries are surrounded completely by the sealing edge.

12. The composite board with a honeycomb cardboard according to claim 1, wherein said bottom board and said honeycomb cardboard and said top board are fixed, their peripheries are surrounded partly by the sealing edge.
